(19) United States
(12) Patent Application Publication
(10) Pub. No.: US 2007/0219818 A1
(43) Pub. Date: Sep. 20, 2007

(54) MOBILE SYSTEM AND METHOD FOR PROCESSING REAL ESTATE TRANSACTIONS

(75) Inventors: Lawrence R. Duthler, Wyoming, MI (US); Thomas W. Cronkright, Rockford, MI (US)

Correspondence Address: DICKINSON WRIGHT PLLC, 1901 L. STREET NW, SUITE 800, WASHINGTON, DC, 20036, US

(73) Assignee: SUN TITLE AGENCY OF MICHIGAN, LLC, Grand Rapids, MI (US)

(21) Appl. No.: 11/687,464

(22) Filed: Mar. 16, 2007

Related U.S. Application Data
(60) Provisional application No. 60/743,541, filed on Mar. 17, 2006.

(51) Int. Cl. G06Q 10/00; G06Q 30/00

(52) U.S. Cl. 705/1

(57) ABSTRACT

A mobile system and method are provided for closing real estate transactions remotely. A mobile closing unit (24), which is included in a housing (20) having a satellite or wireless antenna (48), includes a printer (28) connected to a router (40) having a wireless card (84) for connecting to a wide area network (100) and power switch (76). An office network (36) stores transaction documents relating to a real estate transaction and a subsequent transaction. While in route to or at the remote closing location, the mobile closing unit (24) connects to the office network (36) over the wide area network (100), and prints the documents. The real estate transaction is conducted at a remote closing location, and the executed transaction documents are sent over the wide area network (100) to the office network (36). The housing (20) is moved to a subsequent location and the mobile closing unit (24) connects, while in route to or at the subsequent location, to the office network (36) over the wide area network (100), and prints the documents. The subsequent transaction is conducted at the subsequent location, and the executed transaction documents are sent over the wide area network (100) to the office network (36).

### CROSS REFERENCE TO RELATED APPLICATION

This application claims the benefit of U.S. Provisional Patent Application Ser. No. 60/743541, entitled “Mobile Closing Unit and Method of Delivering Remote Escrow Closing Settlement Services for the Title Insurance Industry,” filed Mar. 17, 2006.

### BACKGROUND OF THE INVENTION

1. Field of the Invention

This invention relates to mobile systems and methods for remotely processing real estate transactions in real-time.

2. Description of the Prior Art

A title insurance company issues title insurance for real property, and sometimes for other high value assets, such as airplanes, vessels and certain vehicles. Title insurance companies typically provide additional real estate services, including title search and examination, title commitment issuance, escrow, closing, settlement, and document recordation. Most of a title company's services are performed in a traditional brick-and-mortar office setting, at least in part because real estate and mortgage transactions must be conducted in the preesence of a title company representative or Notary Public. As a result, buyers, sellers and their agents and representatives typically travel to the title company's office to sign the papers and “close” the transaction.

As interest rates have dropped and more financing options became available for new homeowners, the number of real estate closing transactions has increased significantly. Title companies have limited office space to close all of the requested transactions. The number of transactions a title company could close in a day traditionally limited to the number of conference rooms available in the offices of the title company. Recently, as the number of real estate transactions increased title companies have been limited by physical office constraints, and have three options, (1) move to a new larger office, (2) add additional office space and conference rooms to the current office, and (3) add satellite offices near the main office of the title company. While these options allowed a title company to process more transactions, they also significantly increase the overhead of the title company.

Title companies currently address the physical constraints that limit the number of transactions a title company may close with only two methods, both of which are problematic. The first method is to prepare all necessary closing documents prior to the off-site closing and mail or send by delivery service to the parties involved in a transaction the closing documents. The parties involved in the transaction must then sign the documents in the presence of a Public Notary and return them to the title company by mail or delivery service. Although this method is commonly used, it is very problematic in view of the exemplary problems provided in further detail below and many times does not leave a positive impression with the clients of the title company. The second method is to have the title company provide a Public Notary who obtains the documents from the offices of the title company and then travels to the closing, witnesses the signing of the documents and then returns with the signed documents to the title company. The second method is also problematic as detailed below.

While an off-site closing transaction provides convenience for the parties to the transaction, it often complicates the closing process and increases the risk that the closing will not take place if changes or revisions to the documents are required at the closing. For example, one significant problem with providing the documents by mail or delivery service is the time required to close the transaction after the title company sends the documents. While waiting for the title company to review and approve the signed documents, some of the parties to the transaction may be waiting to receive significant sums of money from the transaction, or waiting for funds from the closing to become available to close on another house. Another problem with mailing the documents is that no matter how clearly the title company provides instructions or labels the documents, the parties, who typically rarely participate in such transactions, make a mistake in the documents. The mistake may be as simple as one party signing in the wrong location, a spouse not signing the documents, signing with a different name, or even not returning a complete set of signed documents to the title company. Furthermore, if the documents are mailed to the parties, the parties must still schedule a time with a Public Notary who must witness the signing of the documents.

Another problem with documents either mailed or brought to the closing by a Public Notary are revisions, that are necessary at the closing, including changes to the loan amount, commission split, new negotiated terms, or any number of additional issues relating to the transaction. These changes commonly occur after the title company sends the documents. A traditional off-site Public Notary is unable to make these changes at the closing. Most changes require new documents from the title company (typically necessitating special title software) and new documents from the lender (which can only be made by the lender and must be re-sent to the title company). Therefore, the parties must request new documents be mailed, or if present, the title company's Public Notary must travel to the title office to obtain new documents.

Another challenge for off-site closings is the inability to receive and disburse secure funds at a remote location. Funds cannot be distributed to the parties at the closing until funds are received from the lender. Funds may be received via wire transfer or check. Once the funds are received and verified, the title company can print, sign and issue the checks. At an off-site closing, a Public Notary does not have the capability to communicate with the lender, deposit funds, or print and sign the checks.

Because off-site Public Notaries do not have access to the necessary title software and cannot receive new documents from the lender, the closing would be cancelled. In addition to causing significant inconvenience and aggravation for all parties involved in the transaction, it is also possible that a delay could effect whether the transaction ever closes. For example, failure to close a transaction as planned may result in the loss of an interest rate lock, expiration of a purchase agreement between a buyer and a seller, the inability to take advantage of tax-deferrals (such as 1031 exchanges), and increased costs due to accrued interest and finance charges on debts to be paid at the closing. Any delay is inefficient and reduces productivity of the title company because many times the document must be significantly changed to account for changes on the date of closing. Delays in closing also negatively effect the reputations of the professionals involved in the transaction.

### SUMMARY OF THE INVENTION AND ADVANTAGES

According to at least one embodiment of the invention a method for processing real estate transactions is provided. The method includes automatically receiving and printing transaction documents relating to a real estate transaction on a printer connected to a router having a wireless card. The router connects through a wide area network, such as the Internet, to a remote network that stores the transaction documents. The transaction documents are received and printed while the printer and the router are in transit to a first location, or when the printer and router are at the first location. The transaction is executed at a designated transaction site.

According to a further aspect of the invention, a mobile system for remotely processing real estate transactions is provided. The system includes an office network including electronically stored transaction documents relating to a first real estate transaction and a second real estate transaction. A mobile closing unit that includes a printer and a router having a wireless card for connecting to the office network through a wide area network and a direct connection to the printer automatically connects to the office network from, or while en route to, a first location. The mobile closing unit downloads and prints the transaction documents relating to the first transaction. The mobile closing unit then moves from the first location to a second location. While en route to, or at either the first or second location, the mobile closing unit automatically connects to the office network to download and print the transaction documents relating to the second transaction. The mobile closing unit may also include an optional computer and/or magnetic check scanner.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 depicts an overhead interior view of the mobile closing unit in an exemplary van;

FIG. 2 depicts a side interior view of the mobile closing unit in an exemplary van;

FIG. 3 depicts an exemplary network configuration that may be used to implement the present invention; and

FIGS. 4a and 4b depict a flow diagram for processing a real estate purchase transaction.

### DETAILED DESCRIPTION OF THE INVENTION

Referring to the Figures, wherein like numerals indicate corresponding parts throughout the several views, a system and method for processing real estate transactions is provided. An exemplary housing 20 depicted in FIG. I includes the components needed to close real estate purchase and re-finance transactions, or other transactions remotely, in real-time, including the components of a mobile closing unit 24 consistent with the present invention.

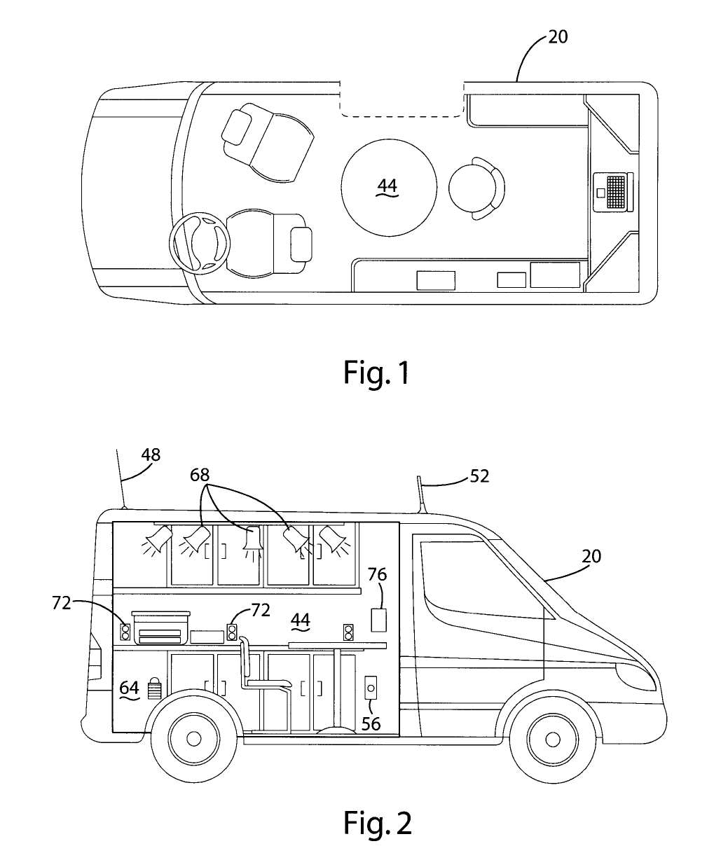

The housing 20 is illustrated in FIG. 1 as a van. While the Figures illustrate the housing 20 as a van, the housing 20 may be any vehicle or method of transportation capable of movement and having sufficient space to accommodate the necessary components of the mobile closing unit 24. Exemplary housings could include an airplane, helicopter, boat, automobile, truck, recreational vehicle or trailer, so long as the unit is easily moveable between closing sites. More specifically, the housing 20 is any mobile vehicle capable of accomodating the components of a mobile closing unit 24, including one or more devices capbable of printing, faxing, scanning, and copying transaction documents, connecting to a remote office network 36 and/or a financial institution 60 in real-time to receive documents, transmitting in real-time executed transaction documents back to the office network 36, and receiving, depositing and disbursing funds, may be used.

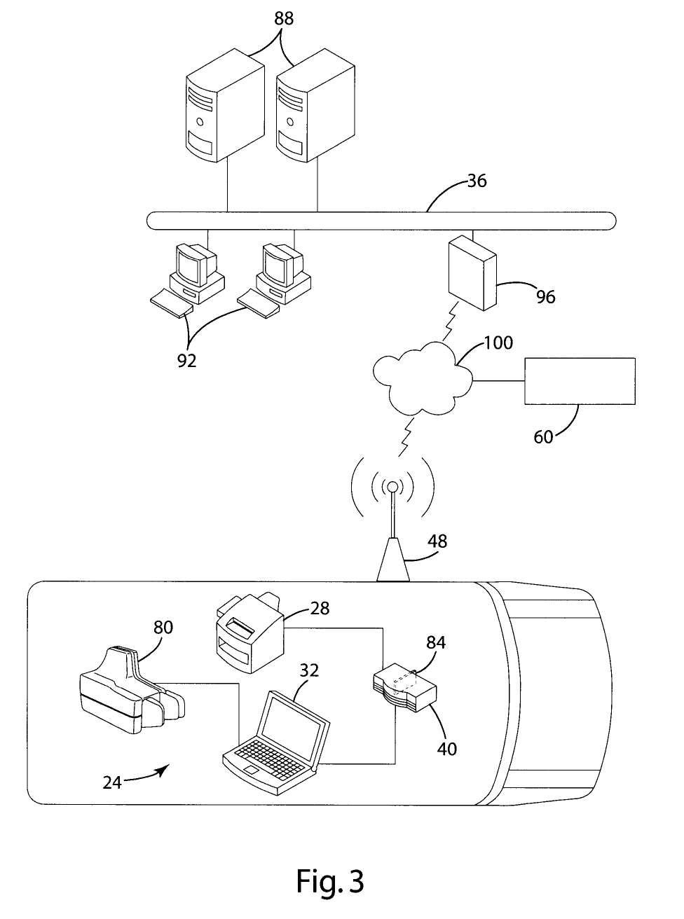

The housing 20 may further include optional items, in addition to the mobile closing unit 24 to facilitate the productivity of the user. As illustrated in FIGS. 1 and 2, the housing 20 may include an optional work surface area 44, chairs, a table, and cabinets. These optional items may be useful in closing a real estate transaction, such as a real estate transaction that occurs offsite at a vacant parcel of land. The housing 20 in some embodiments may include items to facilitate closing of transactions, including real estate transactions in inclimate weather or after a disaster when limited facilities are available for closing a transaction. Even if the work surface and chairs are not used by the parties during the transaction, they still may be useful to the user and facilitate the process of assembling, preparing, or modifying documents. The housing 20 optionally includes a secure storage area 64 to store checks and other important documents pertaining to a transaction.

To further facilitate the productivity of the user, the housing 20 may include lighting 68 and electrical outlets 72. The housing 20 includes a power supply (not shown), typically the alternator of the vehicle, although batteries, a separate generator, solar panels, or other power sources (individually or in conjunction) may act as the power supply. Depending on the vehicle acting as the housing 20, the housing 20 may further include a power converter (not shown) that converts the direct current, such as the 12V systems common for vehicles, to alternating current. The power supply and power converter are sized to provide sufficient power to all of the components included in the mobile closing unit 24. A heavy duty power system that includes an upgraded alternator or a second alternator may be beneficial to providing the necessary power to the power converter. In the preferred embodiment, if the vehicle power supply is a 12V system, the power converter converts the power to 120V alternating current, which is provided to the electrical outlets 72. Of course, if a separate generator is used, such as those commonly used in recreational vehicles, the need for a power converter is eliminated. Providing current and voltage similar to that commonly used in office settings allows the use of standard office equipment in the housing 20, as part of the mobile closing unit 24 and therefore reduces the cost of the mobile closing unit 24, and allows for easy replacement of any components of the mobile closing unit 24.

To facilitate ease of use, the housing 20 may include a power switch 76 that controls power to the mobile closing unit 24. While the components included in the housing 20 and the mobile closing unit 24 itself may be powered by being directly or hard wired into the vehicle's power supply, or more typically through for the wall plugs, the power switch 76 may act as a master switch. Where the housing 20 includes a power converter, the power switch 76 may simply turn the power converter on and off. For example, when the power converter is on, the power and lights of the mobile closing unit 24 are on, and vice versa.

The mobile closing unit 24 allows a user to receive closing documents remotely, make changes to the closing documents, send and receive transmissions to a title company and a lender, deposit funds directly into the title company's bank account, and securely disburse money to the parties. The mobile closing unit 24 when used with real estate transactions generally includes a printer 28, a router 40 having a wireless Internet card, an antenna 48, an optional stand-alone magnetic check scanner 80, and an optional computer 32. The printer 28, optional magnetic check scanner 80, and an optional computer 32 are connected to the office network 36 through the network router 40 and the antenna 48 using a wireless Internet connection.

While any antenna 48 or antenna configuration may be used that allows connection either directly or indirectly to the office network 36, the antenna is typically attached to the housing 20. For example, as illustrated in FIG. 2, the housing 20 includes a high-gain external antenna 48 mounted on its exterior to establish a wireless connection to wide area networks. The housing 20 could alternatively include a wireless cellular antenna 52 mounted to its exterior, and include a cellular antenna interior connection 56, to establish a wireless connection to wide area networks. The mobile closing unit 24 may also include a satellite/wireless antenna 48. The wireless antenna 48 indicates a generic wireless transmission that is capable of receiving and transmitting data from and to, respectively, an office network 36. For example, because cellular signals may not be available in all locations, a satellite communication system that allows sending of data between the mobile closing unit 24 and an office network 36 may be used. In some embodiments, as illustrated in FIG. 2, the housing 20 may include multiple antennas to ensure that no matter the location connection may be made through the most reliable method. However, as satellite internet connections are still expensive, the system may be configured to default to the least expensive method of communication that provides a reliable signal. In some embodiments, the antenna 48 may even allow connection to WiFi and WiMax or other methods of connecting to the office network.

When the mobile closing unit 24 is powered on (typically through the power switch 76), it automatically connects to the office network 36 using a secure, encrypted Internet connection. Upon connection, the title company can transmit closing documents directly to the mobile closing unit 24. While the mobile closing unit 24 is powered off, documents are stored electronically for delivery to the mobile closing unit 24 when it is subsequently powered on. Documents can be transmitted to and printed by the mobile closing unit 24 while it is stationary or in motion.

The router 40 may include a wireless card 84, such as an Evolution Data Optimized (“EVDO”) card, or a card configured to use some other third-party wireless Internet transmission protocol. This wireless card 84 may act as the antenna 48. A specialized EVDO routing device will provide dynamic DNS services to alert the office network 36 as to the location of the mobile closing unit 24. The router 40 includes separate, direct wired connections to the printer 28 and the computer 32. This allows high-speed printing, faxing, and scanning jobs to be sent from the office network 36 directly to the printer 28 included in the mobile closing unit 24 and visa versa. When the power switch 76 is turned on, the router 40 uses the wireless card 84 to automatically connect to the office network 36 through the Internet 100. The router 40 remains connected to the Internet 100 and the office network 36 until it is powered off, even when the mobile closing unit 24 is moving. Of course, one skilled in the art will recognize that an external mounted antenna 48 may provide a more reliable signal.

The printer 28 may be any multi-functional printing device capable of printing, scanning, faxing, and copying documents, such as an HP 4345 multi-function printing unit. The functions performed by the printer 28 could optionally be performed by separate devices for photocopying, printing documents and/or checks, faxing, and scanning. Of course, one benefit of using a multi-function printer is the space saved over using individual components. One skilled in the art will appreciate that the hardware components of the mobile closing unit 24 must be compatible with one another and collectively perform the processing described hereinbelow. For example, a sophisticated router 40 can direct print jobs to multiple devices and print checks on blank check stock via a magnetic printing device and print other documents on a traditional laser printing device. A router 40 with less functionality, however, may only be capable of printing data received from the office network 36 via a single port and thus limited to printing to a single multi-function printing device.

When the printer 28 is turned on, such as by the master switch 76, it automatically connects to the office network 36 through the router 40. Once connected to the office network 36, the printer 28 will automatically receive and print pending and new print jobs sent from the office network 36. An employee working at the office network 36 can send a job to the printer 28 located in the mobile closing unit 24 in the same way that print jobs are sent to printers physically residing in the employee's office. The jobs can be sent to the multi-function printer 28 even when the mobile closing unit 24 system is powered off or in transit. If the printer 28 is not connected to the network, when the mobile closing unit 24 and printer 28 are powered on, the pending job will automatically be recognized by the printer 28 and printed. Otherwise, the print job will wait in the queue until the printer 28 reconnects to the network. If the mobile closing unit 24 is connected to the office network 36, the print job will be printed irrespective whether the vehicle is in motion or stationary.

The printer 28 and the computer 32 operate independently. The computer 32 does not have to be turned on, or even connected to the mobile closing unit 24, for the printer 28 to receive and send documents to and from the office network 36.

The computer 32 may be any laptop or desktop computing device. A docking station may be used to facilitate connecting a laptop to the wireless network. In the event a laptop is used, an additional hard-wired connection may be made between the router 40 and a docking station mounted to the inside of the housing 20 that supports the laptop, thereby providing hard-line access to the Internet and applications and services residing on the office network 36. In addition, a secure 802.11 wi-fi connection secured with medium access control (“MAC”) level security for that specific laptop will be provided so as to enable wireless communication with the laptop from within a 200 foot radius. A network interface included in the computer device 32 may also facilitate transmission of data within the mobile closing unit 24 and between the mobile closing unit 24 and the office network 36. Of course, any other method of connection may be used, including, satellite, and any method of accessing the Internet or office network 36.

When the computer 32 is turned on, it can access the Internet through the router 40. Once connected to the Internet, the computer 32 can then connect to the office network 36 and access the software, files, databases, etc. as if the computer 32 were connected to the office network 36 locally. The computer 32 can send documents to the multi-function printer 28 included in the mobile closing unit 24, or to a remote printer 28 located, for example, in the office.

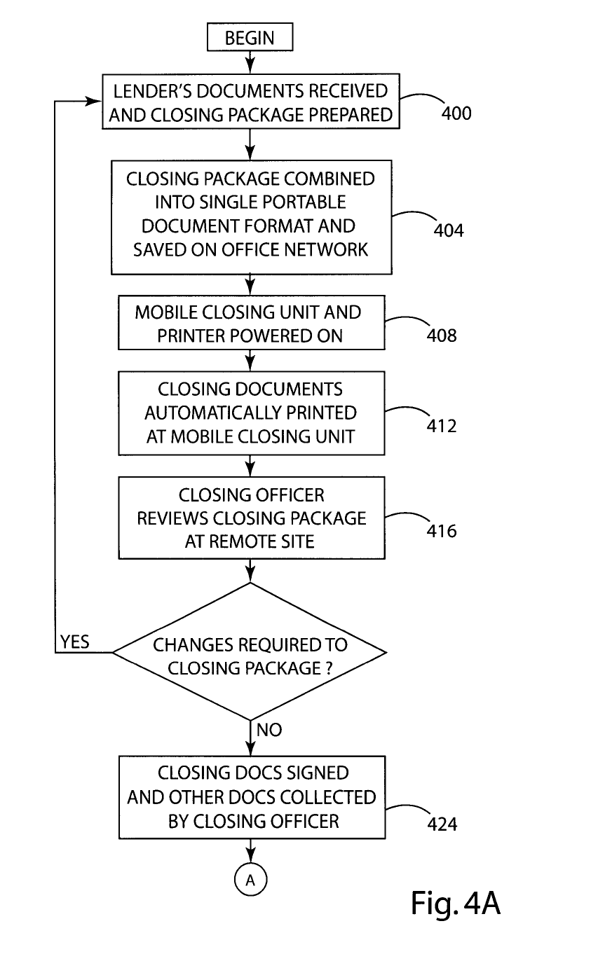

Referring to FIG. 3, a representative system architecture is provided. The office network 36 includes one or more terminal and application servers 88, and one or more workstations 92 connected to a local area network. The local office network 36 connects through a firewall 96 to a wide area network 100, such as the Internet. The workstations 92 have access to title software that is used to generate transaction documents relating to real estate transactions. The transaction documents may include, for example, title closing documents (including checks), lender closing documents, and shipping labels. The office network 36 and mobile closing unit 24 can also connect to a financial institution 60 via the wide area network 100.

A typical transaction using the mobile closing unit 24 includes transmitting and printing documents (including checks and overnight delivery labels), verifying lender funds, depositing funds into the title company's bank account, disbursing checks to the parties, electronically transmitting the closing package to the title company and the lender, copying the closing documents, and, if necessary, making changes to closing documents through the use of specialized title software and receiving new documents from the lender. After closing a transaction, the mobile closing unit 24 is moved to the next closing location and is capable of receiving and printing the next closing package en route.

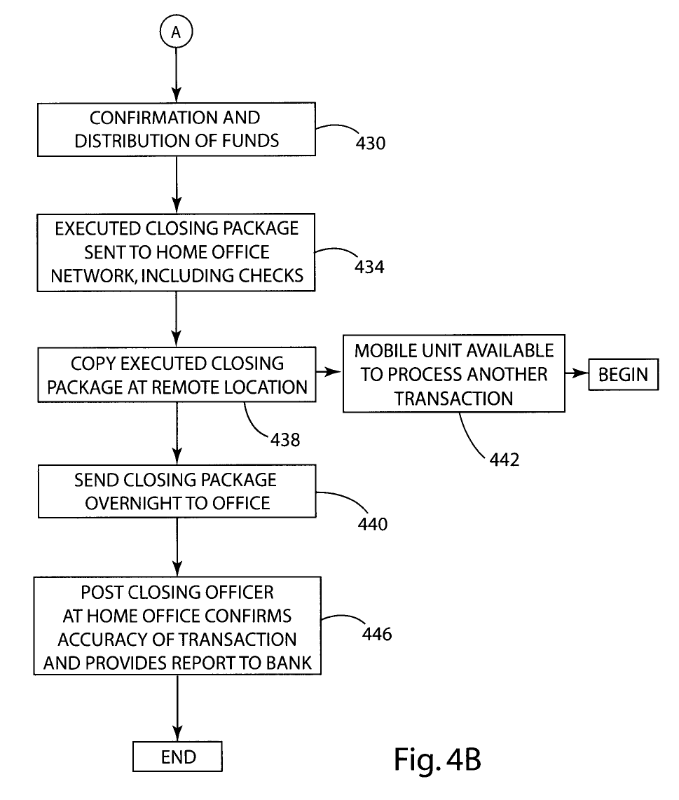

FIGS. 4a and 4b depict the steps performed in a real estate purchase transaction consistent with the system and method provided by the present invention. An escrow officer at the office receives lender closing documents and prepares a closing package for a real estate purchase or re-finance transaction [400]. The closing package includes, for example, title closing documents, lender closing documents, labels, and checks. The closing package is assembled into a single portable document format, such as Adobe, and saved on the office network 36 [404]. When the escrow officer, typically located at the office, has completed assembly of the closing documents, the escrow officer sends the closing package from the office network 36 over the wide area network 100, through the firewall 96, to the printer 28 in the mobile closing unit 24.

When mobile closing unit 24 and the printer 28 are powered on [408], the printer 28 automatically receives and prints the closing package(s) that were sent to it by the escrow officer, including any pending documents in the print queue [412]. This may occur while the mobile closing unit 24 is en route to, or after it has arrived at, the designated location. The location could be the property for which the closing is occurring, a third-party business, or any other location agreed upon by the parties.

The closing officer, typically located in close proximity to the mobile closing unit 24 reviews the closing documents at the remote location [416]. If updates were sent from the office, the closing officer may replace pages of the original documents requiring modification as appropriate.

If changes need to be made to any of the closing documents, the escrow officer can make the changes on the office network 36 and send them to the printer 28 included in the mobile closing unit 24. For example, changes may be received by the escrow officer from the lender, one of the parties, or upon request of the closing officer at the closing. If the mobile closing unit 24 and/or printer 28 are not powered on when the revised documents are sent to it, the documents will automatically print when the mobile closing unit 24 and printer 28 are turned on. Alternatively, if the mobile closing unit 24 includes a computer 32, the closing officer can use the computer 32 to access the office network 36 remotely, and if authorized, make any necessary changes to the closing documents, and re-print the corrected documents. In addition, if changes to the closing package require new documents from the lender, the escrow officer and/or the closing officer can coordinate with the lender to receive and print the revised documents in the mobile closing unit 24.

To ensure maximum confidentiality, personal or other sensitive information, is not stored at the mobile closing unit 24. All electronic copies of the closing documents are stored on a server 88 or workstation 92 at the office and all modifications are made on such workstation 92 or server 88. The closing officer may remotely log into a server 88 located at the office, using any known security system or method, including encrypted connections over a password protected portal. Signed closing documents are scanned and electronically transmitted to the server 88. The physical closing package is promptly shipped back to the office overnight, with no copies retained in the mobile closing unit 24. Any checks received in the mobile closing unit 24 are scanned and electronically deposited into the title company's escrow account. Once scanned, the checks are promptly shipped back to the office overnight and can no longer be presented at another bank. Therefore, if any devices that make up the mobile closing unit 24 are ever stolen from the housing 20, there will be no sensitive data present. However, if the housing 20 includes the optional secure storage, any sensitive items may be stored in this area until dropped off or being shipped back to the office.

As part of the closing process, the closing officer will verify the identity of each of the signatories to the closing transaction. The documents used in verification are typically saved by photocopying or scanning, such as with the multi-function printer 28, or a stand-alone unit and not included as part of the mobile closing unit 24 per se but included in the housing 20 of the mobile closing unit 24 or otherwise located at the remote site.

The final closing package for the transaction is then signed by the appropriate parties to the transaction [424]. The closing officer will need to review the documents to ensure that all necessary signatures are obtained.

The closing officer or the escrow officer must confirm receipt of applicable funds. Funds may be received from the buyer, the seller, lenders, agents, and other interested parties. Once funds are verified, the closing officer can distribute the checks that were printed as part of the closing package. This process may require, for example, using the computer 32 included in the mobile closing unit 24 to access the server 88 at the office, making a secure request to print checks, and designating that the checks are to be printed to the printer 28 in the mobile closing unit 24. If there were no changes to the documents, the checks may have previously been printed with the transaction documents.

The closing officer at the mobile closing unit 24 will confirm that the indicated funds have been received from the lender. The escrow officer or closing officer may optionally transmit the documents to a lender to obtain a funding number as confirmation of funding. If funds are provided to the closing officer at the mobile closing unit 24 during a closing, the received checks can be scanned directly into a designated escrow bank account via a check scanner 80 provided by a bank. Once the funds at issue are verified, they are distributed to the applicable parties to the transaction [430]. Funds may also be sent electronically to participants in the transaction who are not physically present at the closing.

The signed closing documents along with any other documents pertaining to the transaction, such as checks distributed to, or provided by, one or more parties, are scanned from the remote mobile closing unit 24 back to the office network 36 [434]. The scanning may be performed by the multi-function printer 28 or a separate scanning device included in the mobile closing unit 24. The physical copy of the closing package is shipped overnight to the office and/or the lender.

The closing officer at the mobile closing unit 24 copies the executed closing documents and distributes them as appropriate to the parties involved in the closing transaction [438]. The copies may be in electronic or paper format. The lender documents will likely be sent via overnight mail to the lender; the remaining documents are sent via overnight mail to the office [440].

Once this transaction is completed, the closing officer can transport the mobile closing unit 24 to another location, and conduct another transaction [442].

A quality control step is also performed post-closing at the office to ensure that the closing documents are accurate and complete. Any checks distributed during closing are verified, and a corresponding report is transmitted to the bank. This step may be performed on the next business day after a closing occurs, especially for closings being held after normal business hours [446]. No check presented for payment will be honored by a financial institution 60 unless information pertaining to such check has been transmitted to the title company's bank (this is also referred to as “positive pay”).

The modular design of the mobile closing unit 24 allows for comparable components to be substituted for the components described herein. This flexibility is ideal for equipment upgrades as technology evolves, and to quickly and easily replace malfunctioning system components.

The processing of a re-finance transaction according to systems and methods consistent with this invention is similar to that of a purchase transaction. The primary difference is that re-finance transactions are unlikely to require the title company to issue checks at the closing, so associated processing is not necessary. Additionally, re-finance transactions allow for a 3-day right of rescission, whereas purchase transactions do not allow any right of rescission. Thus, the final confirmation of funds and report to the bank pursuant to re-finance transactions occur after the closing.

While this invention has been described with respect to a particular embodiment, many modifications and variations of the invention are possible in light of the above teachings. The illustrations and descriptions provided herein are considered to be exemplary and not restrictive in character, it being understood that only illustrative embodiments have been shown and described and that all changes and modifications that come within the spirit of the disclosure are desired to be protected. The invention may therefore be practiced otherwise than as specifically described while within the scope of the appended claims.

What is claimed is:

1. A method for processing real estate transactions, comprising the steps of;
preparing transaction documents for a first transaction and a second transaction at an office location having an office network;
storing electronically on the office network transaction documents for said first transaction and said second transaction,
providing power to a mobile closing unit included in a housing, said mobile closing unit including a printer connected to a router having a wireless card for connecting to said office network through a wide area network, and a power switch for controlling power to said mobile closing unit,
receiving from said office network over said wide area network and at a location remote from the office location said electronically stored transaction documents relating to said first transaction,
printing on said printer and at a location remote from the office location said transaction documents relating to said first transaction,
executing the transaction documents related to the first transaction at a first location,
scanning said executed transaction documents relating to the first transaction at a location remote from said office location and sending said transaction documents over said wide area network to said office network,
moving said housing from said first location to a second location and said mobile closing unit receiving at a location remote from said office location transaction documents relating to said second transaction,
printing on said printer and at a location remote from said office location said transaction documents relating to said second transaction,
executing said transaction documents relating to said transaction at said second location, and
scanning said executed transaction documents relating to said second transaction at a location remote from said office location and sending said executed transaction documents relating to said second transaction over said wide area network to said office network.

2. The method of claim 1, further comprising receiving at said first location funds from a party to said first transaction, after said step of printing said transaction documents relating to said first transaction.

3. The method of claim 2 further comprising depositing funds received from a party at said first location into an account at a financial institution by scanning and sending said funds over said wide area network.

4. The method of claim 2, further including depositing from said first location said funds into an escrow account by scanning said funds at said first location and transmitting said funds from said first location to said first escrow account via said wide area network.

5. The method of claim 1 wherein, said mobile closing unit further includes a computer having a direct connection to said router.

6. The method of claim 5, further including the step of using said computer at said first location to make edits to said transaction documents relating to said first transaction.

7. The method of claim 6 wherein said step of using said computer to make edits to said transaction documents relating to said first transaction further includes the steps of accessing the electronically stored documents on the office network over said wide area network, and editing the electronically stored documents to create edited transaction documents.

8. The method of claim 7 wherein said step of using said computer to make edits to said transaction documents relating to said first transaction further includes the step of printing said edited transactions documents.

9. The method of claim 8 wherein said step of printing edited transaction documents further includes the step of receiving from the office network over said wide area network said edited transaction documents.

10. The method of claim 9 further including the step of printing the received edited transaction documents at a location remote from the office location.

11. The method of claim 1 further including the steps of contacting at the office location a person authorized to edit transaction documents and editing the transaction documents by the authorized person, said authorized person sending to said printer located in the mobile closing unit said edited transaction documents.

12. The method of claim 11 further including the step of printing at a location remote from the office location the edited transaction documents.

13. The method of claim 12 wherein said edited transaction documents are said documents that are executed at the first location, said method further including the step of printing new checks for at least one party involved in the real estate transaction in view of the edits to the transaction documents.

14. The method of claim 13 further including the step of receiving lender approval of the edited transaction documents before said step of printing new checks.

15. The method of claim 12 further including the step of destroying a check that was printed with said transaction documents relating to the first transaction.

16. The method of claim 12 wherein said mobile closing unit further includes a dedicated check printer and said new checks are printed on said dedicated check printer.

17. The method of claim 1 further including the step of editing said electronically stored transaction documents on said office network relating to one of said first and second transactions and transmitting said edited transaction documents to said printer.

18. The method of claim 17 further including the step of receiving approval of the edited transaction documents from at least one lender.

19. The method of claim 18 further including the step of receiving a funding number from said lender said funding number approving disbursement of funds for at least one of said first and second transactions.

20. The method of claim 18 further including the step of editing said electronically stored transaction documents on said office network relating to one of said first and second transactions and providing to said printer said edited transaction documents, without moving said mobile closing unit from one of said first and second locations.

21. A method for processing real estate transactions, comprising the steps of;
preparing transaction documents for a plurality of transactions at an office location;
storing electronically on an office network said transaction documents for said plurality of transactions;
receiving at a location remote from said office location, while en route to a transaction, or at said first location, said first location being remote from said office location, transaction documents relating to a first transaction of said plurality transactions, said transaction documents relating to said fist transaction being received from said office network over a wide area network;
printing said received transaction documents relating to said first transaction;
executing said transaction documents relating to said first transaction at said first location;
scanning said executed transaction documents relating to said first transaction and sending copies of said scanned documents over said wide area network to said office network,
moving a mobile closing unit capable of printing and scanning documents from said first location to a second location remote from the office location;
executing transaction documents related to a second transaction at said second at said second location remote from said office location, and
scanning said executed transaction documents relating to said second transaction at a location remote from said office location and sending said documents over said wide area network to said office network.

22. The method of claim 21 further including the step of receiving said transaction documents relating to said plurality of transactions and wherein said transaction documents relating to said first transaction are received as part of said plurality of transaction documents.

23. The method of claim 21 wherein said mobile closing unit includes a master power switch and when said master power switch is turned on all of said transaction documents relating to said plurality of transactions are received and printed by the mobile closing unit at a location remote from said office location.

24. The method of claim 23 wherein said mobile closing unit is in transit to a location remote from said office location when said transaction documents are printed.

25. The method of claim 23 wherein said mobile closing unit is stationary at a location remote from said office location when said transaction documents are printed.

26. The method of claim 23 wherein said plurality of transaction documents do not include transaction documents for the second transaction and wherein said transaction documents for the second transaction are provided to the mobile closing unit subsequent to receiving said transaction documents relating to said plurality of transactions.

27. The method of claim 26 wherein said transaction documents relating to said second transaction are printed at a location remote from said office location and after printing transaction documents relating to a third transaction.

28. The method of claim 21 wherein at least one of said transaction documents relating to said plurality of transactions is edited after said mobile closing unit is in transit to a transaction location where a transaction relating to said edited transaction document will be executed and wherein said at least one edited transaction document prints on said printer before said mobile unit arrives at said transaction location.

29. The method of claim 21 further including the step of editing on said office network said electronically stored transaction documents relating to one of said plurality of transactions and sending said edited transaction documents to a printer within the mobile closing unit.

30. The method of claim 29 further including the step of obtaining lender approval of the edited transaction documents wherein said step of obtaining lender approval includes the step of forwarding the edited transaction documents to the lender for approval, and receiving approved transaction documents or verification that the transaction documents have been approved from the lender.

31. A mobile system for processing real estate transactions, comprising:
an office network at an office location including electronically stored transaction documents relating to a plurality of real estate transaction, including at least a first real estate transaction and a second real estate transaction,
a housing including a mobile closing unit that includes a printer, a router having a wireless card for connecting to said office network through a wide area network and a connection to said printer, and a power switch for controlling power to said mobile closing unit, wherein
said mobile closing unit automatically connects, while remote from said office location, to said office network via said wide area network to download and print said transaction documents relating to at least one of said first and second transactions and wherein said mobile closing unit is in communication with said office network during transit to one of said first and second locations as well as at least one of said first and second locations.

32. The mobile system of claim 31 wherein said mobile closing unit automatically connects from a first location to said office network via said wide area network to download and print at said first location said transaction documents relating to said first transaction, and as said housing moves from said first location to a second location and automatically connects to said office network to download and print at said second location on said printer said transaction documents relating to said second transaction.

33. The mobile system of claim 32, wherein said mobile closing unit further includes a computer having a direct connection to said printer and wherein said computer is used to edit a document stored on said office network, and said edited document is downloaded to said printer at said mobile closing unit for printing.

34. The mobile system of claim 32, wherein said mobile closing unit further includes a magnetic check scanner connected to said router.

35. A method for processing real estate transactions, comprising the steps of,
storing electronically on an office network at an office location transaction documents for a transaction,
providing power to a remote mobile closing unit included in a housing, said mobile closing unit including a printer connected to a router having a wireless card for connecting to said office network through a wide area network,
receiving from said office network over said wide area network said electronically stored transaction documents relating to said transaction while said mobile closing unit is in transit to a transaction site remote from said office location, and
printing said transaction documents relating to said transaction on said printer while in transit to said transaction site.

36. The method of claim 35 wherein said step of receiving from said office network is automatically performed once said power switch is turned on, allowing documents to be received remotely from the office location, even when the mobile closing unit is in transit to a transaction location.

37. The method of claim 35 wherein said step of printing said transaction documents is automatically performed once said power switch is turned on, allowing document to be received remotely from the office location even when the mobile closing unit is in transit.

38. A method for processing real estate transactions, comprising the steps of;
automatically receiving and printing transaction documents relating to a real estate transaction on a printer connected to a router having a wireless card for connecting through a wide area network to a remote network that stores said transaction documents, wherein said receiving and printing occur while said printer and said router are in transit from a first location to a second location or at said second location, and
executing said transaction at said second location.

39. A method for processing real estate transactions, comprising the steps of;
storing on an office network at an office location transaction documents for a first transaction and a second transaction,
providing power to a remote mobile closing unit included in a housing, said mobile closing unit including a printer connected to a router having a wireless card for connecting to said office network through a wide area network, and a power switch for controlling power to said mobile closing unit,
automatically receiving and printing from said office network over said wide area network said transaction documents relating to said first transaction while said mobile closing unit is remote from said office location, in transit to a first location, or at said first location
executing at said first location said first transaction,
moving said housing from said first location to a second location
automatically receiving and printing transaction documents relating to said second transaction without visiting said office location, and
executing at said second location said second transaction.

40. A method for processing real estate transactions, comprising the steps of:
storing electronically on an office network title closing documents, lender closing documents, shipping labels, and checks for a first transaction and a second transaction,
providing power to a mobile closing unit at a first location, said mobile closing unit contained in a housing having an antenna and including a computer having a connection to a magnetic check scanner, a printer, and a router having a wireless card for connecting to said office network through a wide area network, said router including a first connection to said printer and a second connection to said computer, and a power switch for controlling power to said mobile closing unit,
receiving at said first location from said office network over said wide area network said title closing documents, lender closing documents, checks and labels relating to said first transaction,
printing on said printer said title closing documents, lender closing documents, said shipping labels, and said checks relating to said first transaction,
executing at said first location said title closing documents and said lender closing documents relating to said first transaction,
receiving at said first location funds from a party to said first transaction,
scanning at said first location said executed title closing documents and said executed lender closing documents relating to said first transaction and sending said executed documents over said wide area network to said office network,
storing said executed documents on said office network,
depositing from said first location said funds into an escrow account by scanning said funds at said first location and transmitting said funds from said first location to said first escrow account via said wide area network,
copying at said first location said executed title closing documents and said executed lender closing documents relating to said first transaction,
distributing a copy of said executed title closing documents and said executed lender closing documents to a plurality of parties involved in said first transaction,
reviewing said executed title closing documents and said executed lender closing documents relating to said first transaction,
authenticating said funds,
moving said housing from said first location to a second location,
said mobile closing unit receiving at said second location title closing documents, lender closing documents, and labels relating to said second transaction,
printing on said printer said title closing documents, said lender closing documents, said labels, and said checks relating to said second transaction,
executing at said second location said title closing documents and said lender closing documents relating to said second transaction,
scanning at said second location said executed title closing documents and said executed lender closing documents relating to said second transaction and sending said executed documents over said wide area network to said office network,
copying at said second location said executed title closing documents and said executed lender closing documents relating to said second transaction,
distributing a copy of said executed title closing documents and said executed lender closing documents to a plurality of parties involved in said second transaction,
reviewing said executed title closing documents and said executed lender closing documents relating to said second transaction.
